(19) United States
(12) Patent Application Publication
(10) Pub. No.: US 2007/0076996 A1
(43) Pub. Date: Apr. 5, 2007

(54) Jockey roller device for running tape of sucker of cleaner

(76) Inventor: Fang Zhong Lv, Lujiang New City (CN)

Correspondence Address: CHARLES E. BAXLEY, ESQ., 90 JOHN STREET, THIRD FLOOR, NEW YORK, NY, 10038, US

(21) Appl. No.: 11/240,109

(22) Filed: Sep. 30, 2005

(51) Int. Cl. F16C 33/60

(52) U.S. Cl. 384/504

(57) ABSTRACT

The present invention provides a jockey roller for tightening the running tape of sucker of cleaner including at least two ball bearings, a shaft for fitting the ball bearings on, in which said ball bearing is comprised of inner ring, balls, dust caps and outer ring, the inner ring is fit on the shaft in tight fit. This structure can efficiently prevent dust from entering the inside of the ball bearing, and from wear-and-tear of bearing, the service life of the production is delayed.

### BACKGROUND OF THE INVENTION

1. Field of the Invention

The present invention relates to a jockey roller device for running tape, and more particularly to a jockey roller for tightening the running tape of sucker of cleaner.

2. Description of Prior Art

So far, the conventional jockey roller device for tension running tape of sucker of cleaner includes a shaft and a needle bearing fit on said shaft, within said needle bearing being a conventional standard piece is comprised of cage, needles, outer ring and dust caps.

In this case, the needle bearing device is not only kept in high production cost, due to the expenses of needle bearing, but also demands high quality of needle bearing for meeting requirement of the whole structure, so that the whole production cost is higher, on the other hand, the needle bearing is fit on the shaft in working fit, so a certain bit gap is kept between them, so that dust is easy to enter the needle bearing from the gap to mix with the lubricant to cohere, further to affect the normally rolling, even to occur the needles broken down, and shortcut the service life.

### OBJECTS AND SUMMARY OF THE INVENTION

It is therefore a main object of the present invention to provide a jockey roller for tightening the running tape of sucker of cleaner with lower manufacture and production costs, which efficiently blocks dust entering, reduces wear-and-tear of bearing and delays service life.

For achieving the object, the present invention provides technique project is to provide a jockey roller for tightening the running tape of sucker of cleaner including at least one ball bearing, a shaft for fitting the ball bearing on, in which said ball bearing is comprised of inner ring, balls, dust caps and outer ring, the inner ring is fit on the shaft in tight fit.

Said jockey roller device includes four ball bearings, said each ball bearing is comprised of inner ring, balls, dust caps and outer ring, in which said inner and outer rings are short cylinders, on their interfacing surfaces are respectively formed a pair of interfacing ball ring grooves for locating balls in, said dust caps are covered on the gap between the inner and outer rings from the both sides respectively and fast, said four ball bearings are mounted on the shaft side by side with the inner rings, and located with two retainer rings catching on the shaft at the both outsides of abreast ball bearings respectively, thereby retaining the four ball bearings on the shaft, the inner ring of said ball bearing is mounted on the shaft in tight fit.

Said jockey roller device includes two conventional ball bearings, a space cylinder and an outer sleeve, each ball bearing is comprised of inner ring, balls, dust caps and outer ring, in which said inner and outer rings are short cylinders, on their interfacing surfaces are respectively formed a pair of interfacing ball ring grooves for locating balls in, said dust caps are covered on the gap between the inner and outer rings from the both sides respectively and fast, within said two ball bearings are mounted on the shaft sandwiching with the space cylinder, and said outer sleeve covers all of them at hollow inside, for retaining them together, the both rims of the outer sleeve are bent inward by riveting treatment so that the both outside edges of abreast arranged ball bearings are fixed at inside of the outer sleeve, meanwhile are kept in a certain space of the space cylinder, the inner ring of each ball bearing is fit on the shaft in tight fit, and the outer ring is matched on the inside of the outer sleeve in tight fit too.

Said jockey roller device includes two ball bearings, a space cylinder and an outer sleeve, each ball bearing is comprised of inner ring, balls, dust caps and outer ring, in which said inner and outer rings are short cylinders, on their interfacing surfaces are respectively formed a pair of interfacing ball ring grooves for locating balls in, said dust caps are covered on the gap between the inner and outer rings from the both sides respectively and fast, within said two ball bearings are mounted on the shaft sandwiching with the space cylinder, and said outer sleeve covers all of them at hollow inside, for retaining them together, the outer sleeve is attached with two retainer rings catching on inside at the both outsides of the abreast ball bearings respectively so that the two ball bearings including the sandwiched space cylinder are all retained in the inside of the outer sleeve, the inner ring of each ball bearing is fit on the shaft in tight fit, and the outer ring is matched on the inside of the outer sleeve in tight fit too.

Said jockey roller device includes a special long-shaft ball bearing, which is mounted on a shaft, said ball bearing is comprised of inner ring, balls, dust caps and outer ring, in which said inner and outer rings are long cylinders, on their interfacing surfaces are respectively formed two interfacing ball ring grooves approaching the both sides respectively on each for locating two ball lines in, said dust caps are covered on the gap between the inner and outer rings from the both sides respectively and fast, within said inner ring has a ring groove formed on the middle portion of the inner side wall, and is fit on the shaft in tight fit, and the outer ring is matched on the inside of the outer sleeve in tight fit too.

By means of the above-mentioned technique project, because the ball bearing is lower manufacturing cost than the needle bearing under the same accuracy requirement, and the whole structure demands lower quality to the ball bearing than to the needle bearing, so common ball bearing can meet the requirement of the whole structure, and the whole cost is decreased, on the other hand, because the inner ring of the ball bearing is fit on the shaft in tight fit without gap for entering dust, so this structure can efficiently prevent dust from entering the inside of the ball bearing, and from wear-and-tear of bearing, the service life of the production is delayed.

### BRIEF DESCRIPTION OF THE DRAWINGS

FIG. 1 is a sectional view showing the first embodiment of the present invention.

FIG. 2 is a sectional view showing the second embodiment of the present invention.

FIG. 3 is a side view showing the third embodiment of the present invention.

FIG. 4 is a sectional view showing the forth embodiment of the present invention.

### DETAILED DESCRIPTION OF PREFERRED EMBODIMENTS

The present invention provides a jockey roller for tightening the running tape of sucker of cleaner including at least one ball bearing 1, a shaft 4 for fitting the ball bearing 1 on, in which said ball bearing 1 is comprised of inner ring 11, balls 12, dust caps 13 and outer ring 14, the inner ring 11 is fit on the shaft 4 in tight fit, so the present invention utilizes ball bearing 1 replace of the conventional needle bearing to decrease the manufacturing cost, meanwhile the whole structure demands lower quality to the ball bearing so that common ball bearing can meet the requirement of the whole structure, on the other hand, because the inner ring 11 of the ball bearing is fit on the shaft in tight fit without gap for entering dust, and the ball bearing 1 can be selected in a common ball bearing 1 covered with dust caps 13 on the both sides, so this structure can efficiently prevent dust from entering the inside of the ball bearing 1, and from wear-and-tear of bearing, the service life of the production is delayed.

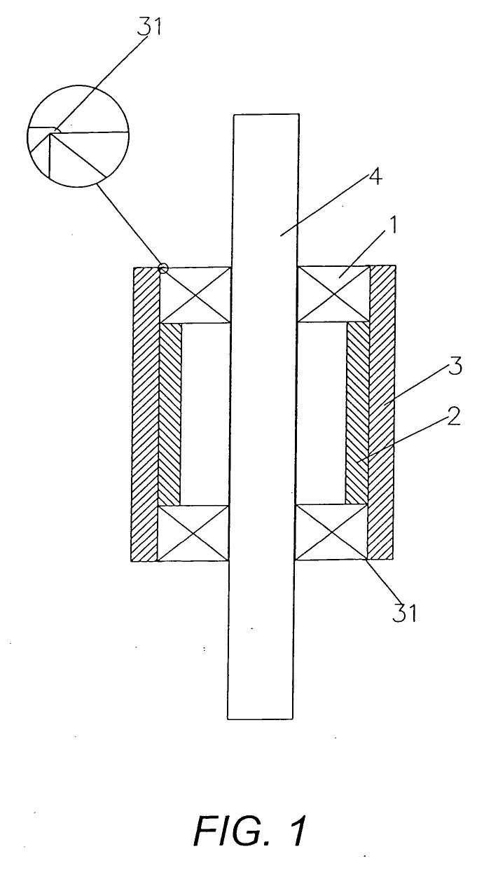

Referring to FIG. 1, the first preferred embodiment of the present invention includes two ball bearings 1, a space cylinder 2 and an outer sleeve 3 each ball bearing 1 is comprised of an inner ring, balls, dust caps and outer ring, in which said inner and outer rings are short cylinders, on their interfacing surfaces are respectively formed a pair of interfacing ball ring grooves for locating balls in, said dust caps are covered on the gap between the inner and outer rings from the both sides respectively and fast, because said ball bearing 1 is selected to the conventional ball bearing, it is not drew out in the drawings. Said two ball bearings 1 are mounted on the shaft 4 sandwiching with the space cylinder 2, and said outer sleeve 3 covers all of them at hollow inside, and the both rims of the outer sleeve 3 are bent inward by riveting treatment to form a flanging 31 so that the both outside edges of abreast arranged ball bearings are fixed at inside of the outer sleeve by the flanging 31 exactly, meanwhile are kept in a certain space of the space cylinder 2; in this embodiment, the inner ring 11 of each ball bearing is fit on the shaft 4 in tight fit, and the outer ring 14 is matched in the outer sleeve 3 in tight fit too.

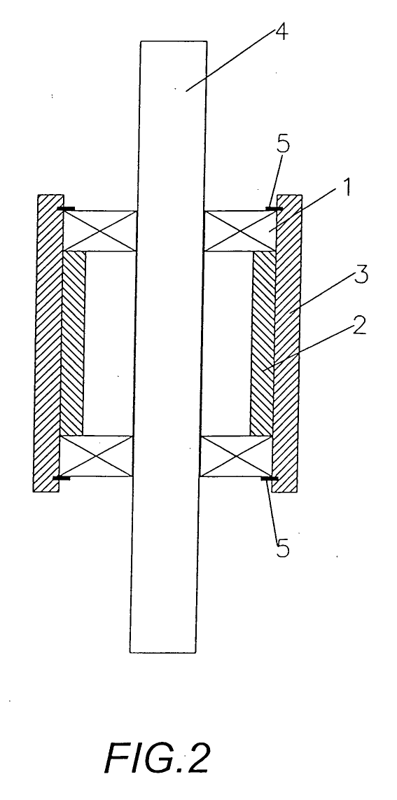

The second embodiment of the present invention, as shown in FIG. 2, includes two ball bearings 1, a space cylinder 2 and an outer sleeve 3. Each ball bearing 1 is comprised of inner ring, balls, dust caps and outer ring, as above-mentioned said ball bearing is conventional ball bearing, so it is not drew out in drawings. Said two ball bearings 1 are mounted on the shaft 4 sandwiching with the space cylinder 2, and said outer sleeve 3 covers all of them at hollow inside, the outer sleeve 3 is attached with two retainer rings 5 catching on inside at the both outsides of the abreast ball bearings 1 respectively so that the two ball bearings 1 including the sandwiched space cylinder are all retained in the inside of the outer sleeve 3. The inner ring 11 of each ball bearing 1 is fit on the shaft 4 in tight fit, and the outer ring 14 is matched in the outer sleeve 3 in tight fit too. The difference of this embodiment and the last embodiment is in the structure of retaining the two ball bearings 1 and the space cylinder 2 in the outer sleeve 3, and actual retaining method is not constrained in the description in this text.

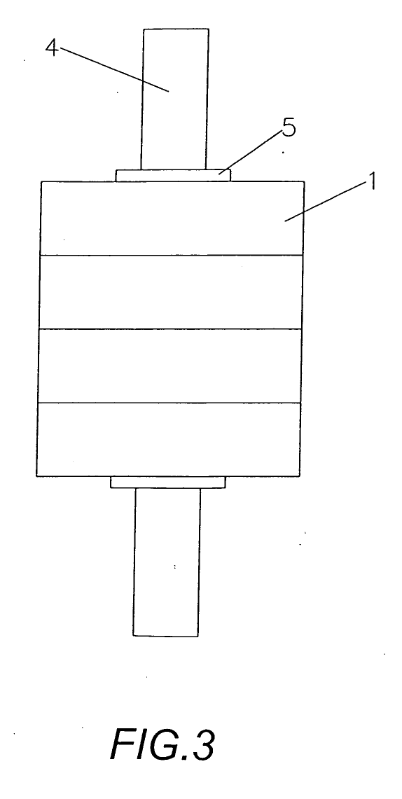

Referring to FIG. 3, the third embodiment of the present invention includes four conventional ball bearings 1, actually depending on the necessary. Each ball bearing 1 is comprised of inner ring, balls, dust caps and outer ring, as above-mentioned said ball bearing is conventional ball bearing, so it is not drew out in drawings. Said four ball bearings 1 are mounted on the shaft 4 side by side, and located with two retainer rings 5 catching on the shaft 4 at the both outsides of abreast ball bearings 1 respectively, thereby retaining the four abreast ball bearings 1 on the shaft 4, the inner ring 11 of each ball bearing 1 is fit on the shaft 4 in tight fit. This embodiment has same functions as above two embodiments.

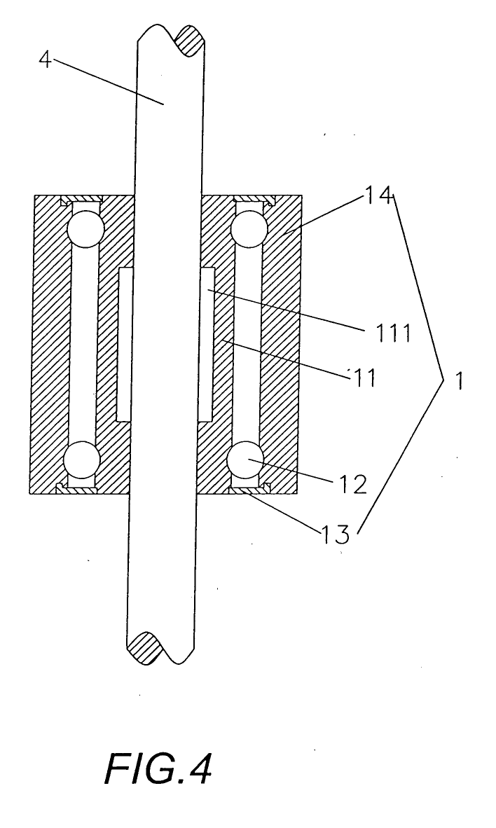

Referring to FIG. 4, the third embodiment of the present invention includes a special long-shaft ball bearing 1, which is mounted on a shaft 4, which is comprised of inner ring 11, balls 12, dust caps 13 and outer ring 14, in which said inner and outer rings 11 14 are long cylinders, on their interfacing surfaces are respectively formed two interfacing ball ring grooves approaching the both sides respectively on each for locating two ball lines in, said dust caps 13 are covered on the gap between the inner and outer rings 11 14 from the both sides respectively and fast, within said inner ring 11 has a ring groove 111 formed on the middle portion of the inner side wall, and is fit on the shaft 4 in tight fit, within said ring groove 111 can efficiently reduce the contacting area between the inner ring 11 and the shaft 4, and allow the inner ring 11 match on the shaft 4 more efficiently with the both ends.

I claim:

1. A jockey roller for tightening the running tape of sucker of cleaner including at least one ball bearing, a shaft for fitting the ball bearings on, in which said ball bearing is comprised of inner ring, balls, dust caps and outer ring, the inner ring is fit on the shaft in tight fit.

2. A jockey roller for tightening the running tape of sucker of cleaner as claimed in claim 1, wherein said jockey roller device includes four ball bearings, said each ball bearing is comprised of inner ring, balls, dust caps and outer ring, in which said inner and outer rings are short cylinders, on their interfacing surfaces are respectively formed a pair of interfacing ball ring grooves for locating balls in, said dust caps are covered on the gap between the inner and outer rings from the both sides respectively and fast, said four ball bearings are mounted on the shaft side by side with the inner rings, and located with two retainer rings catching on the shaft at the both outsides of abreast ball bearings respectively, thereby retaining the four ball bearings on the shaft, the inner ring is fit on the shaft in tight fit.

3. A jockey roller for tightening the running tape of sucker of cleaner as claimed in claim 1, wherein said jockey roller device includes two conventional ball bearings, a space cylinder and an outer sleeve, each ball bearing is comprised of inner ring, balls, dust caps and outer ring, in which said inner and outer rings are short cylinders, on their interfacing surfaces are respectively formed a pair of interfacing ball ring grooves for locating balls in, said dust caps are covered on the gap between the inner and outer rings from the both sides respectively and fast, within said two ball bearings are mounted on the shaft sandwiching with the space cylinder, and said outer sleeve covers all of them at hollow inside, for retaining them together, the both rims of the outer sleeve are bent inward by riveting treatment so that the both outside edges of abreast arranged ball bearings are fixed at inside of the outer sleeve, meanwhile are kept in a certain space of the space cylinder, the inner ring of each ball bearing is fit on the shaft in tight fit, and the outer ring is matched on the inside of the outer sleeve in tight fit too.

4. A jockey roller for tightening the running tape of sucker of cleaner as claimed in claim 1, wherein said jockey roller device includes two ball bearings, a space cylinder and an outer sleeve, each ball bearing is comprised of inner ring, balls, dust caps and outer ring, in which said inner and outer rings are short cylinders, on their interfacing surfaces are respectively formed a pair of interfacing ball ring grooves for locating balls in, said dust caps are covered on the gap between the inner and outer rings from the both sides respectively and fast, within said two ball bearings are mounted on the shaft sandwiching with the space cylinder, and said outer sleeve covers all of them at hollow inside, for retaining them together, the outer sleeve is attached with two retainer rings catching on inside at the both outsides of the abreast ball bearings respectively so that the two ball bearings including the sandwiched space cylinder are all retained in the inside of the outer sleeve, the inner ring of each ball bearing is fit on the shaft in tight fit, and the outer ring is matched on the inside of the outer sleeve in tight fit too.

5. A jockey roller for tightening the running tape of sucker of cleaner as claimed in claim 1, wherein said jockey roller device includes a special long-shaft ball bearing, which is mounted on a shaft, said ball bearing is comprised of inner ring, balls, dust caps and outer ring, in which said inner and outer rings are long cylinders, on their interfacing surfaces are respectively formed two interfacing ball ring grooves approaching the both sides respectively on each for locating two ball lines in, said dust caps are covered on the gap between the inner and outer rings from the both sides respectively and fast, within said inner ring has a ring groove formed on the middle portion of the inner side wall, and is fit on the shaft in tight fit, and the outer ring is matched on the inside of the outer sleeve in tight fit too.
